(19) United States
(12) Patent Application Publication
(10) Pub. No.: US 2022/0134437 A1
(43) Pub. Date: May 5, 2022

(54) THREE-DIMENSIONAL SHAPING APPARATUS

(71) Applicant: SEIKO EPSON CORPORATION, Tokyo (JP)

(72) Inventor: Takeshi MIYASHITA, Sendai-shi (JP)

(21) Appl. No.: 17/452,791

(22) Filed: Oct. 29, 2021

(30) Foreign Application Priority Data
Oct. 30, 2020 (JP) 2020-182081

(51) Int. Cl. B22F 10/85; B33Y 30/00; B33Y 50/02; B28B 1/00; B28B 17/00; B22F 12/43

(52) U.S. Cl. CPC B22F 10/85; B33Y 30/00; B22F 12/43; B28B 1/001; B28B 17/0081; B33Y 50/02

(57) ABSTRACT

A three-dimensional shaping apparatus includes a stage, a first material supply unit that supplies a first material, a second material supply unit that supplies a second material having a sintering temperature higher than a melting point of the first material, a laser irradiation unit, and a control unit that controls the laser irradiation unit by selecting a first laser irradiation mode and a second laser irradiation mode in which heat diffusion to a lower layer is smaller than in the first laser irradiation mode, wherein the control unit controls the laser irradiation unit by selecting the second laser irradiation mode when a second material shaped layer formed by supplying the second material onto a first material shaped layer formed by supplying the first material onto the stage is irradiated with a laser from the laser irradiation unit.

The present application is based on, and claims priority from JP Application Serial Number 2020-182081, filed Oct. 30, 2020, the disclosure of which is hereby incorporated by reference herein in its entirety.

### BACKGROUND

### 1. Technical Field

The present disclosure relates to a three-dimensional shaping apparatus.

### 2. Related Art

Heretofore, three-dimensional shaping apparatuses for producing a three-dimensional shaped article by stacking shaped layers have been used. Among these, there is a three-dimensional shaping apparatus that stacks shaped layers using multiple materials. For example, WO 2016/121013 (Patent Document 1) discloses a laser powder additive manufacturing apparatus for producing a three-dimensional shaped article constituted by multiple materials by supplying a resin powder onto a resin or metal substrate and irradiating the resin powder with a laser.

The laser powder additive manufacturing apparatus disclosed in Patent Document 1 supplies a resin powder onto a resin or metal substrate and irradiates the resin powder with a laser, and therefore, an upper layer having a sintering temperature equal to or lower than a melting point of a lower layer is to be irradiated with the laser. However, when an upper layer having a sintering temperature higher than a melting point of a lower layer is irradiated with a laser, there is a fear that heat due to the laser is transferred to the lower layer, and the lower layer is melted and deformed by the heat due to the laser, and the production accuracy of the three-dimensional shaped article is deteriorated.

### SUMMARY

A three-dimensional shaping apparatus according to the present disclosure for solving the above problem is a three-dimensional shaping apparatus for producing a three-dimensional shaped article by stacking shaped layers on a lower layer, and includes a stage, a first material supply unit that supplies a first material, a second material supply unit that supplies a second material having a sintering temperature higher than a melting point of the first material, a laser irradiation unit, and a control unit that controls the laser irradiation unit by selecting a first laser irradiation mode and a second laser irradiation mode in which heat diffusion to the lower layer is smaller than in the first laser irradiation mode, wherein the control unit controls the laser irradiation unit by selecting the second laser irradiation mode when a second material shaped layer as the shaped layer formed by supplying the second material onto a first material shaped layer as the shaped layer formed by supplying the first material onto the stage is irradiated with a laser from the laser irradiation unit.

### BRIEF DESCRIPTION OF THE DRAWINGS

FIG. 1 is a schematic front view showing a configuration of a three-dimensional shaping apparatus of an embodiment of the present disclosure.

FIG. 2 is a schematic front view showing a configuration of a material supply unit of the three-dimensional shaping apparatus in FIG. 1.

FIG. 3 is a schematic perspective view showing a screw of the three-dimensional shaping apparatus in FIG. 1.

FIG. 4 is a schematic plan view showing a state where a shaping material is filled in the screw of the three-dimensional shaping apparatus in FIG. 1.

FIG. 5 is a schematic plan view showing a barrel of the three-dimensional shaping apparatus in FIG. 1.

FIG. 6 is a schematic front view showing a state where a three-dimensional shaped article is produced using the three-dimensional shaping apparatus in FIG. 1.

FIG. 7 is a flowchart of one example of a three-dimensional shaping method using the three-dimensional shaping apparatus in FIG. 1.

FIG. 8 is a graph showing an energy intensity distribution of a laser to be used when laser irradiation is performed using the three-dimensional shaping apparatus in FIG. 1.

FIG. 9 is a graph showing a heat distribution in a depth direction of a material of a laser to be used when laser irradiation is performed using the three-dimensional shaping apparatus in FIG. 1.

### DESCRIPTION OF EXEMPLARY EMBODIMENTS

First, the present disclosure will be schematically described.

A three-dimensional shaping apparatus according to a first aspect of the present disclosure for solving the above problem is a three-dimensional shaping apparatus for producing a three-dimensional shaped article by stacking shaped layers on a lower layer, and includes a stage, a first material supply unit that supplies a first material, a second material supply unit that supplies a second material having a sintering temperature higher than a melting point of the first material, a laser irradiation unit, and a control unit that controls the laser irradiation unit by selecting a first laser irradiation mode and a second laser irradiation mode in which heat diffusion to the lower layer is smaller than in the first laser irradiation mode, and is characterized in that the control unit controls the laser irradiation unit by selecting the second laser irradiation mode when a second material shaped layer as the shaped layer formed by supplying the second material onto a first material shaped layer as the shaped layer formed by supplying the first material onto the stage is irradiated with a laser from the laser irradiation unit.

According to this aspect, the apparatus not only has a first laser irradiation mode, but also has a second laser irradiation mode in which heat diffusion to the lower layer is smaller than in the first laser irradiation mode. Then, the second laser irradiation mode is selected when a second material shaped layer that is an upper layer formed by supplying a second material having a sintering temperature higher than a melting point of a first material onto a first material shaped layer that is a lower layer formed by supplying the first material onto a stage is irradiated with a laser from a laser irradiation unit. According to this, when the upper layer having a sintering temperature higher than the melting point of the lower layer is irradiated with the laser, heat due to the laser can be prevented from being transferred to the lower layer. Therefore, when the second material shaped layer is stacked on the first material shaped layer and the second material shaped layer is irradiated with a laser, deformation of the first material shaped layer by heat due to the laser can be suppressed.

The three-dimensional shaping apparatus according to a second aspect of the present disclosure is characterized in that, in the first aspect, in the second laser irradiation mode, a laser with a shorter pulse width than in the first laser irradiation mode is used.

According to this aspect, in the second laser irradiation mode, a laser with a shorter pulse width than in the first laser irradiation mode is used. By using a laser with a short pulse width, heat diffusion can be reduced, and therefore, when the second material shaped layer is stacked on the first material shaped layer and the second material shaped layer is irradiated with a laser, deformation of the first material shaped layer by heat due to the laser can be suppressed.

The three-dimensional shaping apparatus according to a third aspect of the present disclosure is characterized in that, in the first aspect, at least in the second laser irradiation mode, a laser having an energy intensity distribution with a top-hat profile is used.

According to this aspect, a laser having an energy intensity distribution with a top-hat profile is used in the second laser irradiation mode. By using the laser having an energy intensity distribution with a top-hat profile, as compared to a case where a laser having an energy intensity distribution of a Gaussian distribution is used, a thermal energy to be applied to a meltable region with a constant width can be evenly applied, supply of an excessive thermal energy as in the case of a Gaussian distribution is suppressed, and heat diffusion over a wide range can be suppressed. Therefore, when the second material shaped layer is stacked on the first material shaped layer and the second material shaped layer is irradiated with a laser, deformation of the first material shaped layer by heat due to the laser can be suppressed.

The three-dimensional shaping apparatus according to a fourth aspect of the present disclosure is characterized in that, in any one of the first to third aspects, the first material is a resin.

According to this aspect, the first material is a resin. Therefore, when the upper layer is stacked on a resin layer that is the lower layer and the upper layer is irradiated with a laser, deformation of the resin layer that is the lower layer by heat due to the laser can be suppressed.

The three-dimensional shaping apparatus according to a fifth aspect of the present disclosure is characterized in that, in any one of the first to fourth aspects, the second material is a metal or a ceramic.

According to this aspect, the second material is a metal or a ceramic. Therefore, when a metal layer or a ceramic layer is stacked on the lower layer and the metal layer or the ceramic layer is irradiated with a laser, deformation of the lower layer by heat due to the laser can be suppressed. In particular, in a case where the lower layer is a resin layer, when a metal layer or a ceramic layer is stacked on the resin layer that is the lower layer and the metal layer or the ceramic layer is irradiated with a laser, deformation of the resin layer that is the lower layer by heat due to the laser can be particularly effectively suppressed.

Hereinafter, embodiments according to the present disclosure will be described with reference to the accompanying drawings. Note that the following drawings are all schematic views, and some constituent members are omitted or simplified. Further, in the respective drawings, an X-axis direction is a horizontal direction, a Y-axis direction is a horizontal direction and also a direction perpendicular to the X-axis direction, and a Z-axis direction is a vertical direction.

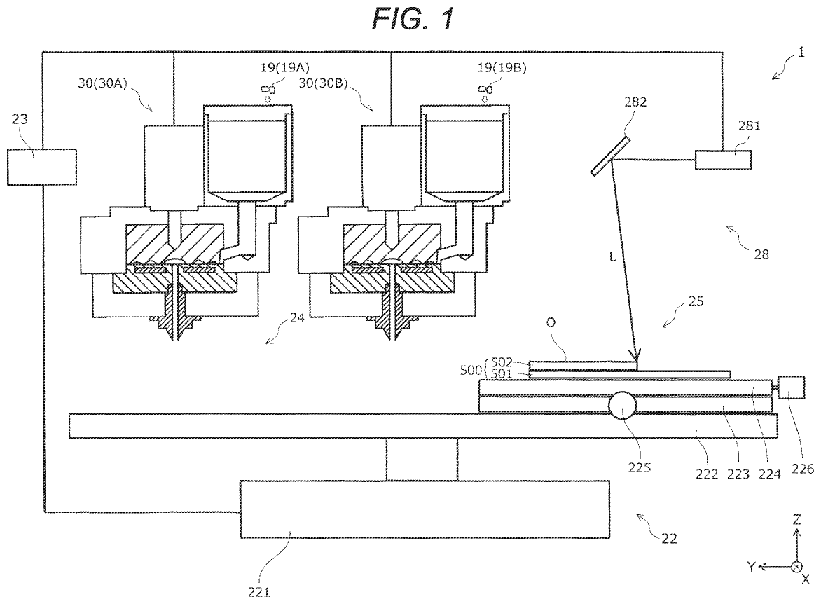

First, the overall configuration of a three-dimensional shaping apparatus 1 of an embodiment of the present disclosure will be described with reference to FIGS. 1 to 5.

The three-dimensional shaping apparatus 1 of the present embodiment is a three-dimensional shaping apparatus for producing a three-dimensional shaped article O by stacking shaped layers 500 using a first material Oa and a second material Ob, and sintering at least the second material Ob with a laser L. The first material Oa may be configured not to be sintered or may be configured to be sintered. As shown in FIG. 1, the three-dimensional shaping apparatus 1 of the present embodiment includes two material supply units 30 that supply a material for forming the shaped layers 500, a stage unit 22 as a stage for shaping the three-dimensional shaped article O, and a laser irradiation unit 28 capable of irradiating the shaped layer with the laser L. In addition, the three-dimensional shaping apparatus 1 includes a control unit 23 that controls driving of the respective constituent members of the three-dimensional shaping apparatus 1 such as the material supply units 30, the stage unit 22, and the laser irradiation unit 28.

The three-dimensional shaping apparatus 1 of the present embodiment includes a first material supply unit 30A that supplies the first material Oa and a second material supply unit 30B that supplies the second material Ob as the material supply units 30. As the second material Ob, a material having a sintering temperature higher than the melting point of the first material Oa is used. In the three-dimensional shaping apparatus 1 of the present embodiment, a pellet 19 can be used as a shaping material for shaping the three-dimensional shaped article O. That is, a pellet 19A containing the first material Oa is used in the first material supply unit 30A, and a pellet 19B containing the second material Ob is used in the second material supply unit 30B. In the pellet 19A, another material such as a binder may be contained other than the first material Oa, and in the pellet 19B, another material such as a binder may be contained other than the second material Ob. Here, in the three-dimensional shaping apparatus 1 of the present embodiment, the first material supply unit 30A and the second material supply unit 30B have exactly the same configuration.

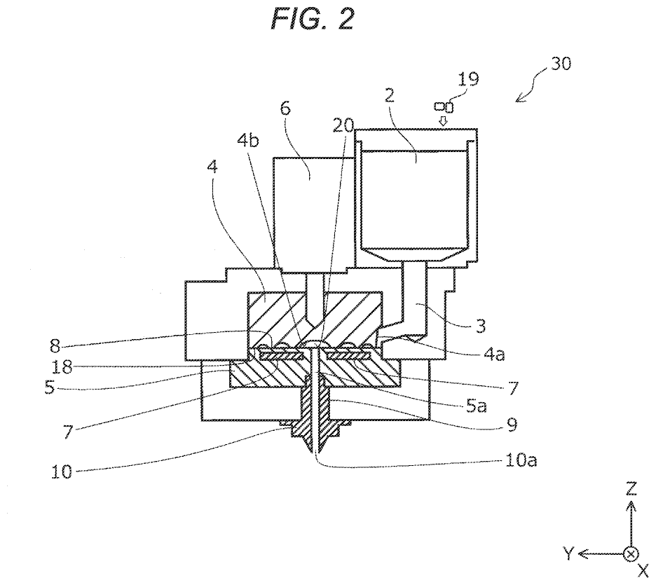

FIG. 2 shows the material supply unit 30, however, the first material supply unit 30A and the second material supply unit 30B have exactly the same configuration, and therefore, FIG. 2 corresponds to both the first material supply unit 30A and the second material supply unit 30B. As shown in FIG. 2, the material supply unit 30 includes a hopper 2 that stores the pellet 19 as the shaping material for shaping the three-dimensional shaped article O. The pellet 19 stored in the hopper 2 is supplied to a circumferential face 4a of a screw 4 that is a flat screw having a substantially columnar shape through a supply pipe 3.

The three-dimensional shaping apparatus 1 of the present embodiment has a configuration in which the pellet 19 is used as the shaping material for shaping the three-dimensional shaped article O, and the shaping material is ejected while plasticizing the shaping material by the flat screw, however, the present disclosure is not limited to the three-dimensional shaping apparatus 1 having such a configuration. For example, a configuration in which the three-dimensional shaped article O is shaped by continuously ejecting a filament that is a linear shaping material made of a resin or a metal filament in which a resin material is mixed in a metal powder from an ejection section while melting the filament, or the like may be adopted. Further, a configuration in which the three-dimensional shaped article O is shaped by ejecting a fluid in which the first material Oa or the second material Ob is dissolved in a solvent or dispersed in a dispersion medium from an ejection section, or the like may be adopted.

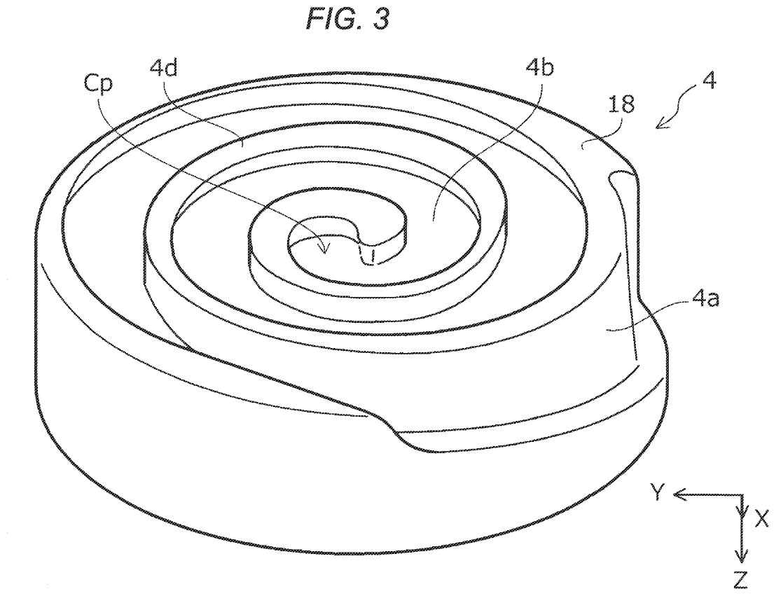

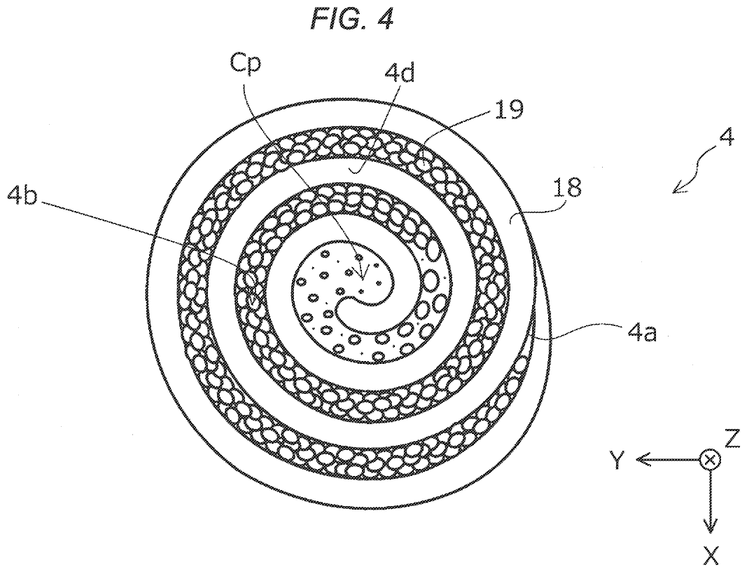

As shown in FIG. 3, in a grooved face 18 that is a bottom face of the screw 4, a groove 4b in a spiral shape extending from the circumferential face 4a to a central portion Cp is formed. In other words, a rib 4d formed with the formation of the groove 4b forms the grooved face 18. The three-dimensional shaping apparatus 1 of the present embodiment supplies the pellet 19 from the circumferential face 4a to the central portion Cp while plasticizing the pellet 19 as shown in FIG. 4 by rotating the screw 4 with a direction along the Z-axis direction as the rotational axis by a driving motor 6 shown in FIG. 2. Although not shown in FIG. 1, in order to prevent the temperature of the driving motor 6 from increasing, cooling water circulates in the vicinity of the driving motor 6.

As shown in FIG. 2, at a position opposed to the grooved face 18 of the screw 4, a barrel 5 is provided with a predetermined interval. In the vicinity of an opposed face 8 that is an upper face of the barrel 5 and is opposed to the grooved face 18, a heating section 7 is provided. Since the screw 4 and the barrel 5 have such a configuration, by rotating the screw 4, the pellet 19 is supplied to a space portion 20 formed between the grooved face 18 of the screw 4 and the opposed face 8 of the barrel 5 as well as corresponding to the position of the groove 4b, and the pellet 19 moves from the circumferential face 4a to the central portion Cp. When the pellet 19 moves in the space portion 20 by the groove 4b, the pellet 19 is melted by heat of the heating section 7, and also is pressurized by a pressure caused by the movement in the narrow space portion 20. By plasticizing the pellet 19 in this manner, the pellet 19 is supplied to a nozzle 10a through a communication hole 5a and ejected from the nozzle 10a.

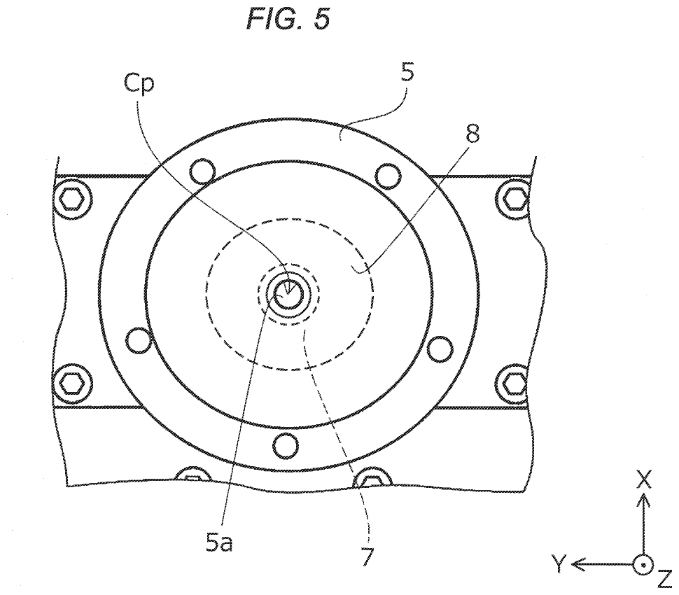

As shown in FIG. 5 or the like, in the central portion Cp of the barrel 5 in plan view, the communication hole 5a that is a movement path of the molten pellet 19 is formed. As shown in FIG. 2, the communication hole 5a is coupled to the nozzle 10a of an ejection section 10 that ejects the shaping material. The communication hole 5a is provided with an unillustrated filter. Although not formed in the barrel 5 of the present embodiment, a groove to be coupled to the communication hole 5a may be formed in the opposed face 8 of the barrel 5. By forming a groove to be coupled to the communication hole 5a in the opposed face 8, the shaping material sometimes tends to gather toward the communication hole 5a.

Here, the ejection section 10 is configured to be able to continuously eject the shaping material in a fluid state by being plasticized from the nozzle 10a. As shown in FIG. 2, the ejection section 10 is provided with a heater 9 for adjusting the viscosity of the shaping material to a desired value. The shaping material to be ejected from the ejection section 10 is ejected in a linear shape. Then, by ejecting the shaping material in a linear shape from the ejection section 10, the shaped layer 500 is formed.

The three-dimensional shaping apparatus 1 of the present embodiment includes the material supply unit 30 including the hopper 2, the supply pipe 3, the screw 4, the barrel 5, the driving motor 6, the ejection section 10, etc. The three-dimensional shaping apparatus 1 of the present embodiment is configured to include one first material supply unit 30A that ejects the first material Oa and one second material supply unit 30B that ejects the second material Ob, but may be configured to include a plurality of at least either first material supply units 30A or second material supply units 30B.

Further, as shown in FIG. 1, the three-dimensional shaping apparatus 1 of the present embodiment includes the stage unit 22 for placing the shaped layer 500 formed by ejection from the material supply unit 30. The stage unit 22 includes a base portion 221, a first table 222, a second table 223, and a third table 224. The first table 222 has a size extending from a shaped layer forming region 24 by the material supply unit 30 to a laser irradiation region 25 by the laser irradiation unit 28 to be described in detail later in the Y-axis direction, and the second table 223 can move along the Y-axis direction with respect to the first table 222 by a motor 225 under the control of the control unit 23. Further, the third table 224 can move along the X-axis direction with respect to the second table 223 by a motor 226 under the control of the control unit 23. Note that there is no particular restriction on the configuration of the stage unit 22, and for example, a table and a motor for moving the second table 223 and the third table 224 from the shaped layer forming region 24 to the laser irradiation region 25 may be further additionally provided.

The three-dimensional shaping apparatus 1 of the present embodiment is configured to be able to move the second table 223 and the third table 224 from the shaped layer forming region 24 to the laser irradiation region 25 by moving the second table 223 along the Y-axis direction with respect to the first table 222. By locating the second table 223 and the third table 224 in the shaped layer forming region 24, the shaped layer 500 is formed by the material supply unit 30, and by locating the second table 223 and the third table 224 in the laser irradiation region 25, laser irradiation is performed by the laser irradiation unit 28.

The material supply unit 30 is configured to be able to move along the Z-axis direction by an unillustrated motor as the shaped layers 500 are stacked in the shaped layer forming region 24, and also the laser irradiation unit is configured to be able to move along the Z-axis direction by an unillustrated motor as the shaped layers 500 are stacked in the laser irradiation region 25. Since the three-dimensional shaping apparatus 1 of the present embodiment has such a configuration, the shaped layer 500 can be formed on the third table 224 while relatively moving the stage unit 22 and the material supply unit 30 in the shaped layer forming region 24, and also the shaped layer 500 formed on the third table 224 can be irradiated with the laser L at a desired position while relatively moving the stage unit 22 and the laser irradiation unit 28 in the laser irradiation region 25. Control of the arrangement of the stage unit 22 and the material supply unit 30 and control of the arrangement of the stage unit 22 and the laser irradiation unit 28 are both performed by the control unit 23.

As shown in FIG. 1, the laser irradiation unit 28 includes a laser irradiation section 281 and a Galvano mirror 282. The laser irradiation unit 28 irradiates the laser L by oscillating the laser L at a predetermined output power from the laser irradiation section 281 based on a control signal from the control unit 23. The laser L is irradiated onto the shaped layer 500 and sinters and solidifies, for example, a metal powder or the like contained in the shaped layer 500. At this time, a binder or the like contained in the shaped layer 500 is simultaneously evaporated by heat of the laser L. The laser L is not particularly limited, but a fiber laser has an advantage that the absorption efficiency into a metal or the like is high, and therefore is favorably used. Further, a Q-switched and pulse-controlled YAG laser may also be used.

Here, the first material Oa and the second material Ob are not particularly limited, but as the first material Oa, a resin can be preferably used. In the three-dimensional shaping apparatus 1 of the present embodiment, when an upper layer is stacked on a resin layer that is a lower layer obtained using a resin as the first material Oa and the upper layer is irradiated with the laser L, deformation of the resin layer that is the lower layer by heat due to the laser L can be suppressed.

Further, as the second material Ob, a metal or a ceramic can be preferably used. In the three-dimensional shaping apparatus 1 of the present embodiment, when a metal layer or a ceramic layer is stacked on a lower layer and the metal layer or the ceramic layer is irradiated with the laser L, deformation of the lower layer by heat due to the laser L can be suppressed. In particular, in the three-dimensional shaping apparatus 1 of the present embodiment, in a case where the lower layer is a resin layer, when a metal layer or a ceramic layer is stacked on the resin layer that is the lower layer and the metal layer or the ceramic layer is irradiated with the laser L, deformation of the resin layer that is the lower layer by heat due to the laser L can be particularly effectively suppressed.

However, as described above, the first material Oa and the second material Ob are not particularly limited, and any of a metal, a ceramic, a resin, etc. may be used, and also two or more types thereof may be mixed and used. However, it is a prerequisite that the sintering temperature of the second material Ob is higher than the melting point of the first material Oa.

Specific examples of the metal or the ceramic that can be used in the first material Oa and the second material Ob include various metals such as aluminum, titanium, iron, copper, magnesium, a stainless steel, and a maraging steel, various metal oxides such as silica, alumina, titanium oxide, zinc oxide, zirconium oxide, tin oxide, magnesium oxide, and potassium titanate, various metal hydroxides such as magnesium hydroxide, aluminum hydroxide, and calcium hydroxide, various metal nitrides such as silicon nitride, titanium nitride, and aluminum nitride, various metal carbides such as silicon carbide and titanium carbide, various metal sulfides such as zinc sulfide, various metal carbonates such as calcium carbonate and magnesium carbonate, various metal sulfates such as calcium sulfate and magnesium sulfate, various metal silicates such as calcium silicate and magnesium silicate, various metal phosphates such as calcium phosphate, various metal borates such as aluminum borate and magnesium borate, composite compounds and the like thereof, and gypsum (various hydrates of calcium sulfate and anhydrous calcium sulfate).

Further, examples of the resin that can be used in the first material Oa and the second material Ob include an acrylic resin, an epoxy resin, a silicone resin, a cellulosic resin, and synthetic resins. Additional examples thereof include thermoplastic resins such as PLA (polylactic acid), PA (polyamide), and PPS (polyphenylene sulfide). When a resin is used as the second material Ob to be sintered by laser irradiation, a heat-resistant resin called a super engineering plastic such as PEEK (polyether ether ketone) can be preferably used. Further, the material may be formed into a pellet state or the like in which the resin is contained together with a metal or a ceramic. Further, the above-mentioned metal, ceramic, or resin in a fine particle state instead of a pellet state may be dissolved or dispersed in a solvent or a dispersion medium. A dissolving agent such as a solvent or a dispersion medium or a binder is generally removed by drying before irradiation with the laser L or is decomposed with irradiation with the laser L and disappears.

Examples of the solvent or the dispersion medium not only include various types of water such as distilled water, pure water, and RO water, but also include alcohols such as methanol, ethanol, 2-propanol, 1-butanol, 2-butanol, octanol, ethylene glycol, diethylene glycol, and glycerin, ethers (cellosolves) such as ethylene glycol monomethyl ether (methyl cellosolve), esters such as methyl acetate, ethyl acetate, butyl acetate, and ethyl formate, ketones such as acetone, methyl ethyl ketone, diethyl ketone, methyl isobutyl ketone, methyl isopropyl ketone, and cyclohexanone, aliphatic hydrocarbons such as pentane, hexane, and octane, cyclic hydrocarbons such as cyclohexane and methylcyclohexane, aromatic hydrocarbons having a long-chain alkyl group and a benzene ring such as benzene, toluene, xylene, hexyl benzene, heptyl benzene, octyl benzene, nonyl benzene, decyl benzene, undecyl benzene, dodecyl benzene, tridecyl benzene, and tetradecyl benzene, halogenated hydrocarbons such as methylene chloride, chloroform, carbon tetrachloride, and 1,2-dichloroethane, aromatic heterocycles containing any one of pyridine, pyrazine, furan, pyrrole, thiophene, and methyl pyrrolidone, nitriles such as acetonitrile, propionitrile, and acrylonitrile, amides such as N,N-dimethylamide and N,N-dimethylacetamide, carboxylates, and other various types of oils. The solvent or the dispersion medium is generally removed by drying before irradiation with the laser L.

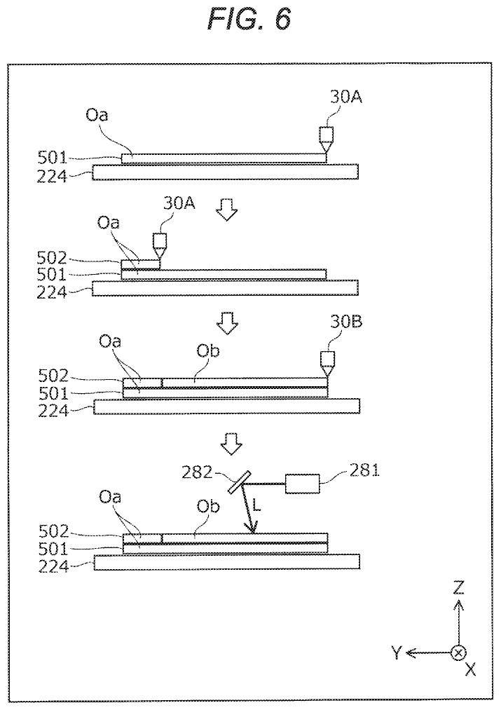

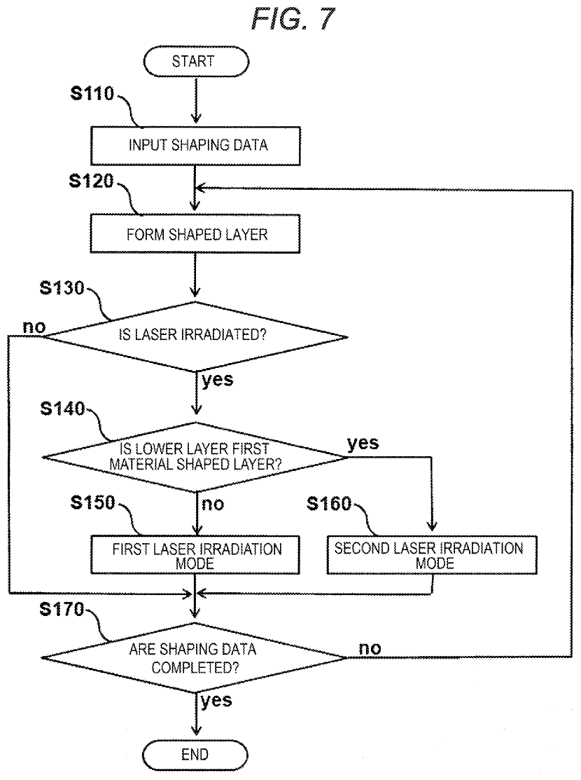

Next, one example of a three-dimensional shaping method to be executed using the above-mentioned three-dimensional shaping apparatus 1 will be described using the flowchart in FIG. 7 with reference to FIG. 6. In the three-dimensional shaping method of the present embodiment, first, in Step S110, the three-dimensional shaping apparatus 1 inputs shaping data from an unillustrated external computer or the like.

Subsequently, in Step S120, the shaped layer 500 for one layer is formed based on the shaping data input in Step S110. Here, the topmost state diagram in FIG. 6 shows a state where a shaped layer 501 being a first layer composed of the first material Oa is formed on the third table 224 by the first material supply unit 30A. In the topmost state diagram in FIG. 6, the shaped layer 501 being the first layer composed only of the first material Oa is formed on the third table 224, however, there is also a case where the shaped layer 501 being the first layer composed of the first material Oa and the second material Ob is formed on the third table 224, or a case where the shaped layer 501 being the first layer composed only of the second material Ob is formed on the third table 224.

Subsequently, in Step S130, it is determined by the control unit 23 whether or not the shaped layer 500 formed in Step S120 is to be irradiated with the laser L. In the present embodiment, the first material Oa is a resin and the second material Ob is a metal, and only a portion formed of the second material Ob in the shaped layer 500 is to be irradiated with the laser L. Therefore, for example, when the shaped layer 501 being the first layer is formed only of the first material Oa in Step S120, the control unit 23 determines that the shaped layer 501 is not to be irradiated with the laser L. When it is determined that the laser L is to be irradiated in this step, the process proceeds to Step S140, and when it is determined that the laser L is not to be irradiated in this step, the process proceeds to Step S170.

In Step S140, it is determined by the control unit 23 whether or not the lower layer that is a layer just below the shaped layer 500 immediately after being formed in Step S120 is a layer formed of the first material Oa. The “layer formed of the first material Oa” also includes a case of being a layer in which only a portion thereof is formed of the first material Oa. When it is determined in this step that the lower layer is not a layer formed of the first material Oa, the process proceeds to Step S150, and laser irradiation is performed in a first laser irradiation mode for the shaped layer 500 immediately after being formed in Step S120. On the other hand, when it is determined in this step that the lower layer is a layer formed of the first material Oa, the process proceeds to Step S160, and laser irradiation is performed in a second laser irradiation mode for the shaped layer 500 immediately after being formed in Step S120.

Step S150 and Step S160 are both steps of sintering the shaped layer 500 immediately after being formed in Step S120. More specifically, these are steps of sintering the shaped layer 500 immediately after being formed in Step S120 without melting or the like of the lower layer. When the second material Ob is a metal or a ceramic, the metal or the ceramic is sintered in Step S150 or Step S160, however, also in a case where the second material Ob is a resin, for example, when a super engineering plastic or the like is used as the resin, the resin is sintered in Step S150 or Step S160. In the present embodiment, the first material Oa is not sintered, however, also the first material Oa is to be irradiated with the laser L and the first material Oa may also be sintered.

Here, the first laser irradiation mode is a laser irradiation mode in a normal state, and the second laser irradiation mode is a laser irradiation mode in which heat diffusion to the lower layer is smaller than in the first laser irradiation mode. Specifically, the second laser irradiation mode is a laser irradiation mode in which a laser with a shorter pulse width than in the first laser irradiation mode is used. With the completion of Step S150 and Step S160, the process proceeds to Step S170.

In Step S170, it is determined by the control unit 23 whether or not the three-dimensional shaping based on the shaping data input in Step S110 is all completed. When it is determined that the three-dimensional shaping based on the shaping data input in Step S110 is all completed, the three-dimensional shaping method of the present embodiment is terminated. On the other hand, when it is determined that the three-dimensional shaping based on the shaping data input in Step S110 is not completed, the process returns to Step S120, and the process from Step S120 to Step S170 is repeated until it is determined that the three-dimensional shaping based on the shaping data input in Step S110 is all completed.

Here, the second state diagram from the top in FIG. 6 shows a state where after the shaped layer 501 being the first layer as a first material shaped layer is shaped, a shaped layer 502 being a second layer is formed of the first material Oa on the shaped layer 501 by the first material supply unit 30A. Then, the third state diagram from the top in FIG. 6 shows a state where the remaining portion of the shaped layer 502 being the second layer is formed of the second material Ob adjacent to the first material Oa on the shaped layer 501 by the second material supply unit 30B. In this manner, the shaped layer 502 includes a portion formed of the second material Ob. Among the shaped layers 500, the shaped layer 502 including a portion formed of the second material Ob is determined as a second material shaped layer. Therefore, it is determined that for the shaped layer 502 as the second material shaped layer, the portion formed of the second material Ob is to be irradiated with the laser L in Step S130. Further, the shaped layer 501 that is the lower layer of the shaped layer 502 is the shaped layer 500 formed of the first material Oa, and therefore, for the shaped layer 502, laser irradiation is performed in the second laser irradiation mode in Step S140. The lowermost state diagram in FIG. 6 shows a state where for the shaped layer 502, laser irradiation is performed in the second laser irradiation mode.

In this manner, the control unit 23 controls the laser irradiation unit 28 by selecting the first laser irradiation mode and the second laser irradiation mode. Then, the control unit 23 controls the laser irradiation unit 28 by selecting the second laser irradiation mode when the second material shaped layer formed by supplying the second material Ob as in the case of the shaped layer 502 in FIG. 6 onto the first material shaped layer formed by supplying the first material Oa onto the stage as in the case of the shaped layer 501 in FIG. 6 is irradiated with the laser L from the laser irradiation unit 28.

In this manner, the three-dimensional shaping apparatus 1 of the present embodiment not only has the first laser irradiation mode, but also has the second laser irradiation mode in which heat diffusion to the lower layer is smaller than in the first laser irradiation mode. Then, when the second material shaped layer that is the upper layer formed by supplying the second material Ob having a sintering temperature higher than the melting point of the first material Oa onto the first material shaped layer that is the lower layer formed by supplying the first material Oa onto the stage is irradiated with the laser from the laser irradiation unit 28, the second laser irradiation mode is selected. According to this, when the upper layer having a sintering temperature higher than the melting point of the lower layer is irradiated with the laser L, the three-dimensional shaping apparatus 1 of the present embodiment can prevent heat due to the laser L from being transferred to the lower layer. Therefore, when the second material shaped layer is stacked on the first material shaped layer and the second material shaped layer is irradiated with the laser L, the three-dimensional shaping apparatus 1 of the present embodiment can suppress deformation of the first material shaped layer by heat due to the laser L.

Further, as described above, in the three-dimensional shaping apparatus 1 of the present embodiment, in the second laser irradiation mode, the laser L with a shorter pulse width than in the first laser irradiation mode is used. By using the laser L with a short pulse width, heat diffusion can be reduced. This is because as the pulse width is shortened, energy can be collected at a pinpoint. Therefore, when the second material shaped layer is stacked on the first material shaped layer and the second material shaped layer is irradiated with the laser L, the three-dimensional shaping apparatus 1 of the present embodiment can suppress deformation of the first material shaped layer by heat due to the laser L.

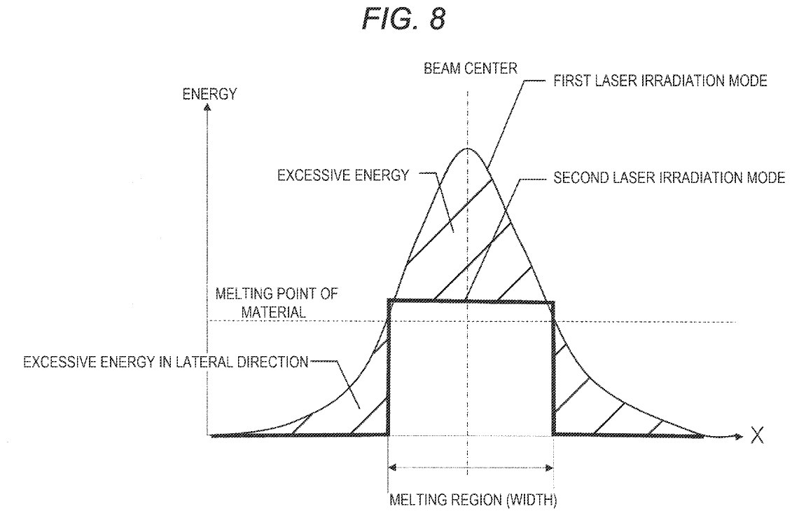

Further, in the three-dimensional shaping apparatus 1 of the present embodiment, it is also possible to use the laser L having an energy intensity distribution with a top-hat profile in the second laser irradiation mode and to use the laser L having an energy intensity distribution of a Gaussian distribution in the first laser irradiation mode. FIG. 8 is a graph showing examples of energy intensity distributions of the laser L having an energy intensity distribution with a top-hat profile and the laser L having an energy intensity distribution of a Gaussian distribution.

Here, the laser L having an energy intensity distribution with a top-hat profile is formed by integrating a lens system (a unit that converts a Gaussian distribution to a distribution with a top-hat profile) using a diffractive optical element (DOE) or the like capable of converting a laser profile to a top-hat distribution into an optical system of a laser light source having a Gaussian distribution generally adopted in a selective laser sintering (SLS) system or a selective mask sintering (SMS) system. However, the lens system is not particularly limited, and can be appropriately selected according to an intended purpose, and for example, StarLite (device name), manufactured by Ophir Optronics Solutions, Ltd., or the like can be used.

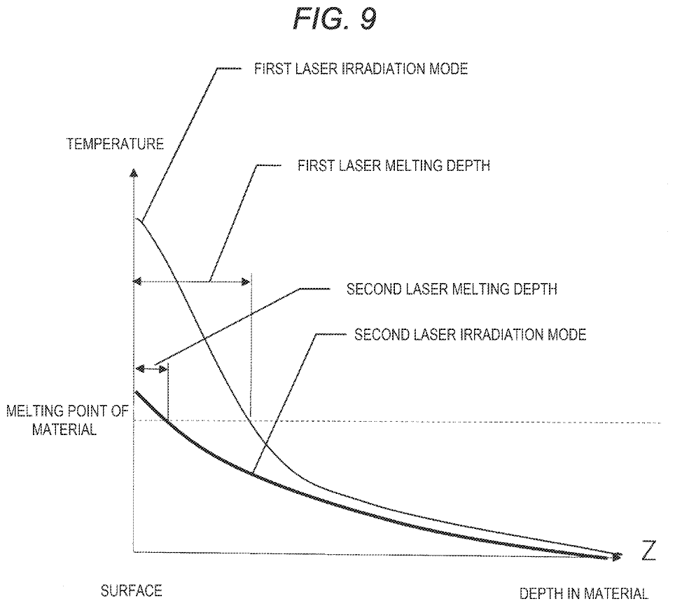

By using the laser L having an energy intensity distribution with a top-hat profile, as compared to a case where the laser L having an energy intensity distribution of a Gaussian distribution is used, a thermal energy to be applied to a meltable region with a constant width can be evenly applied, supply of an excessive thermal energy as in the case of a Gaussian distribution is suppressed, and heat diffusion over a wide range can be suppressed. This is because as also indicated in the graphs of an energy distribution shown in FIG. 8 and a heat distribution in a depth direction of a material shown in FIG. 9, by using the laser L having an energy intensity distribution with a top-hat profile, a thermal energy to be applied to a meltable region with a constant width can be evenly applied in an amount necessary for melting, supply of an excessive thermal energy as in the case of a Gaussian distribution is suppressed, and heat diffusion over a wide range can be suppressed. Therefore, when the second material shaped layer is stacked on the first material shaped layer and the second material shaped layer is irradiated with the laser L, the three-dimensional shaping apparatus 1 of the present embodiment can suppress deformation of the first material shaped layer by heat due to the laser L.

As described above, the three-dimensional shaping apparatus 1 of the present embodiment is configured to be able to adopt a method of changing a pulse width and a method of changing a pulse shape between the first laser irradiation mode and the second laser irradiation mode in which heat diffusion to the lower layer is smaller than in the first laser irradiation mode. However, the three-dimensional shaping apparatus 1 may be configured to adopt only one of the methods or may be configured to adopt a yet another method.

The present disclosure is not limited to the above-mentioned embodiments, but can be realized in various configurations without departing from the gist thereof. The technical features in the embodiments corresponding to the technical features in the respective aspects described in “SUMMARY” of the present disclosure may be appropriately replaced or combined for solving part or all of the problems described above or achieving part or all of the effects described above. Further, the technical features may be appropriately deleted unless they are described as essential features in the present specification.

What is claimed is:

1. A three-dimensional shaping apparatus for producing a three-dimensional shaped article by stacking shaped layers on a lower layer, comprising:
a stage;
a first material supply unit that supplies a first material;
a second material supply unit that supplies a second material having a sintering temperature higher than a melting point of the first material;
a laser irradiation unit; and
a control unit that controls the laser irradiation unit by selecting a first laser irradiation mode and a second laser irradiation mode in which heat diffusion to the lower layer is smaller than in the first laser irradiation mode, wherein
the control unit controls the laser irradiation unit by selecting the second laser irradiation mode when a second material shaped layer as the shaped layer formed by supplying the second material onto a first material shaped layer as the shaped layer formed by supplying the first material onto the stage is irradiated with a laser from the laser irradiation unit.

2. The three-dimensional shaping apparatus according to claim 1, wherein
in the second laser irradiation mode, a laser with a shorter pulse width than in the first laser irradiation mode is used.

3. The three-dimensional shaping apparatus according to claim 1, wherein
at least in the second laser irradiation mode, a laser having an energy intensity distribution with a top-hat profile is used.

4. The three-dimensional shaping apparatus according to claim 1, wherein the first material is a resin.

5. The three-dimensional shaping apparatus according to claim 1, wherein the second material is a metal or a ceramic.
